(19) United States
(12) Patent Application Publication
(10) Pub. No.: US 2004/0084264 A1
(43) Pub. Date: May 6, 2004

(54) Damping force generating valve of a hydraulic shock absorber

(76) Inventor: Kazuhiko Yonezawa, Tokyo (JP)

Correspondence Address: RABIN & Berdo, PC, 1101 14TH STREET, NW, SUITE 500, WASHINGTON, DC, 20005, US

(21) Appl. No.: 10/682,855

(22) Filed: Oct. 14, 2003

(30) Foreign Application Priority Data
Oct. 31, 2002 (JP) 2002-318081

(51) Int. Cl. F16F 9/49

(52) U.S. Cl. 188/282.5; 188/280

(57) ABSTRACT

A damping force generating valve of a hydraulic shock absorber is provided with: a piston portion (6) in a hydraulic shock absorber; an extension side port and a pressure side port drilled in the piston portion (6); and a plurality of leaf valves (5a, 5b, 12, and 15) which are seated so at to be capable of opening and closing one of the extension side port and the pressure side port, which are disposed in the piston portion (6) in a stacked state, and which are fixed to an inner circumferential side. At least one leaf valve (12) of the plurality of leaf valves (5a, 5b, 12, and 15) has a thin sheet valve body (19) and a thick portion (16) provided along a circumferential direction in an intermediate portion of the thin sheet valve body (19), or in an outer edge side of the thin sheet valve body (19), contacting adjacent leaf valves (5a and 15). The leaf valve (12) is structured by providing the thick portion (16) along the circumferential direction in the intermediate portion of the thin sheet valve body (19), or in the outer edge side of the thin sheet valve body (19), and therefore assembly time can be shortened. In addition, assembly costs can also be reduced.

### FIELD OF THE INVENTION

The present invention relates to a damping force generating valve of a hydraulic shock absorber used in a suspension apparatus of a vehicle, such as an automobile.

### BACKGROUND OF THE INVENTION

A shock absorber used in a suspension apparatus of a vehicle, such as an automobile, is configured to generate an optimal damping force in an expansion and contraction stroke in order to suitably relieve vibrations that are transmitted to a vehicle body from a road surface during travel, increasing ride comfort and stability.

A hydraulic shock absorber cited in JP 2001-20991 A, issued by the Japan Patent Office in 2001, is provided with: a pressure side damping force generating valve, which is provided in a rod chamber side surface of a piston portion, and which is seated so as to be capable of opening and closing a pressure side port drilled in the piston portion; and an extension side damping force generating valve that is provided in a piston chamber side surface, and that is seated capable of opening and closing an extension side port formed in the piston portion.

The pressure side damping force generating valve and the extension side damping force generating valve are structured by stacking a plurality of thin disk shaped damping force generating leaf valves. The pressure side damping force generating valve is fixed to an inner circumferential side by a pressure side spacer, and a valve stopper, which are disposed in a piston rod side. Further, the extension side damping force generating valve is fixed to the inner circumferential side by an extension side spacer, a valve stopper, and a nut, which are disposed in a piston chamber side.

As shown by a straight line P in FIG. 5, a relationship between a moving speed of the piston and the damping force generated at that time is substantially linear with this type of damping force generating structure. However, the damping force when the piston moves at high speed should be lowered as shown by a curve Q in order to increase steering stability and ride comfort of the automobile.

In order to achieve these types of damping force characteristics, such a structures has been employed recently that an initial load is imparted toward ports in the pressure side damping force generating valve or in the extension side damping force generating valve.

As shown in FIG. 6, for example, a pressure side damping force generating valve 5 is constructed by overlapping a plurality of leaf valves 5a, 5b, 12, and 15. The second leaf valve 12 is stacked on an upper surface of the leaf valve 5a, which is seated in a pressure side port. A thin inner circumference valve 13, and a thick outer circumference valve 14 that is disposed in an outer circumference of the thin inner circumference valve 13, structure the second leaf valve 12. A gap S is formed between the inner circumference valve 13, and the third leaf valve 15 that is stacked on the upper surface of the inner circumference valve 13, and the gap S corresponds to the difference in thickness between the valves 13 and 14.

Each of the leaf valves 5a, 5b, 12, and 15 is placed in a compressed state by using this type of structure. An inner circumferential side of the third leaf valve 15, and an inner circumferential side of the leaf valve 5b that is stacked on an upper surface of the third leaf valve 15, bend toward the compression side port side in accordance with the gap S.

An initial load thus develops in the pressure side damping force generating valve, toward the compression port. The relationship between the piston speed and the generated damping force becomes that shown by the curve Q in FIG. 5.

However, problems such as the following are present with the structure described above where an initial load is imparted.

That is, the thin inner circumference valve 13 and the thick outer circumference valve 14 disposed in the outer periphery of the thin inner circumference valve 13 structure the second leaf valve 12. Two parts are therefore used, which means an increase in the number of parts, and manufacturing costs and assembly costs increase.

In particular, if positioning of the thin inner circumference valve 13 and the thick outer circumference valve 14 is not performed accurately during their assembly, assembly failures will develop where the outer circumference valve 14 rides up on the inner circumference valve 13. The assembly process must therefore be performed carefully, and the manufacturing costs and assembly costs increase.

### SUMMARY OF THE INVENTION

An object of the present invention is therefore to provide a damping force generating valve of a hydraulic shock absorber, in which the number of parts is decreased, assembly characteristics are improved, and in addition, assembly costs are reduced.

In order to achieve the above object, this invention provides a damping force generating valve of a hydraulic shock absorber, comprising, a piston portion in the hydraulic shock absorber, one of an extension side port and a pressure side port drilled in the piston portion, and a plurality of leaf valves that are seated so as to be capable of opening and closing one of the extension side port and the pressure side port, which are disposed in the piston portion in a stacked state, and which are fixed to an inner circumferential side, wherein at least one leaf valve of the plurality of leaf valves has, a thin sheet valve body, and a thick portion provided along a circumferential direction in an intermediate portion of the thin sheet valve body, or in an outer edge side of the thin sheet valve body, contacting adjacent leaf valves.

The details as well as other features and advantages of this invention are set forth in the remainder of the specification and are shown in the accompanying drawings.

### BRIEF DESCRIPTION OF THE DRAWINGS

FIG. 1 is a cross sectional diagram that shows a piston portion of an embodiment of the present invention.

FIG. 2 is a blown up cross sectional diagram of a portion of the piston portion shown in FIG. 1.

FIG. 3 is a perspective view of a damping force generating valve that shows an embodiment of the present invention.

FIG. 4 is a perspective view that shows a valve body and a ring that structure the damping force generating valve of FIG. 3.

FIG. 5 is a diagram that shows a relationship between piston speed and generated damping force in a conventional hydraulic shock absorber.

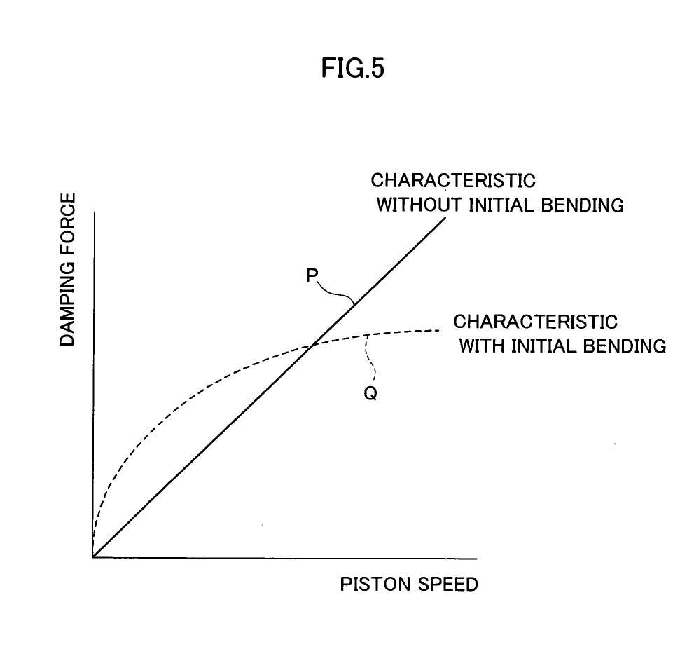

FIG. 6 is a blown up cross sectional diagram of a portion of a conventional piston portion.

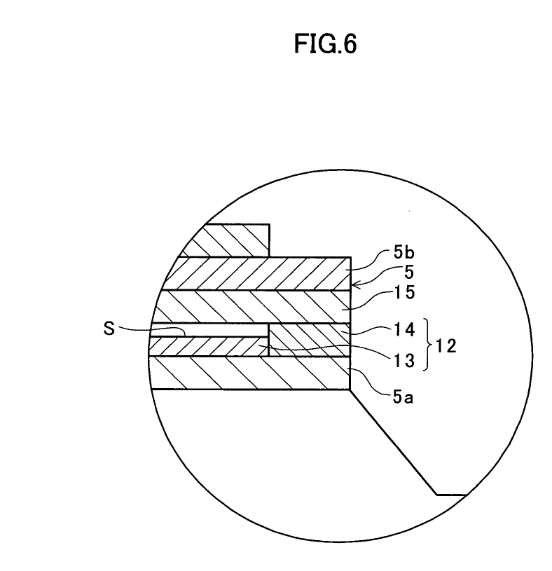

### DESCRIPTION OF THE PREFERRED EMBODIMENTS

Embodiments of the present invention are explained below based on the accompanying drawings.

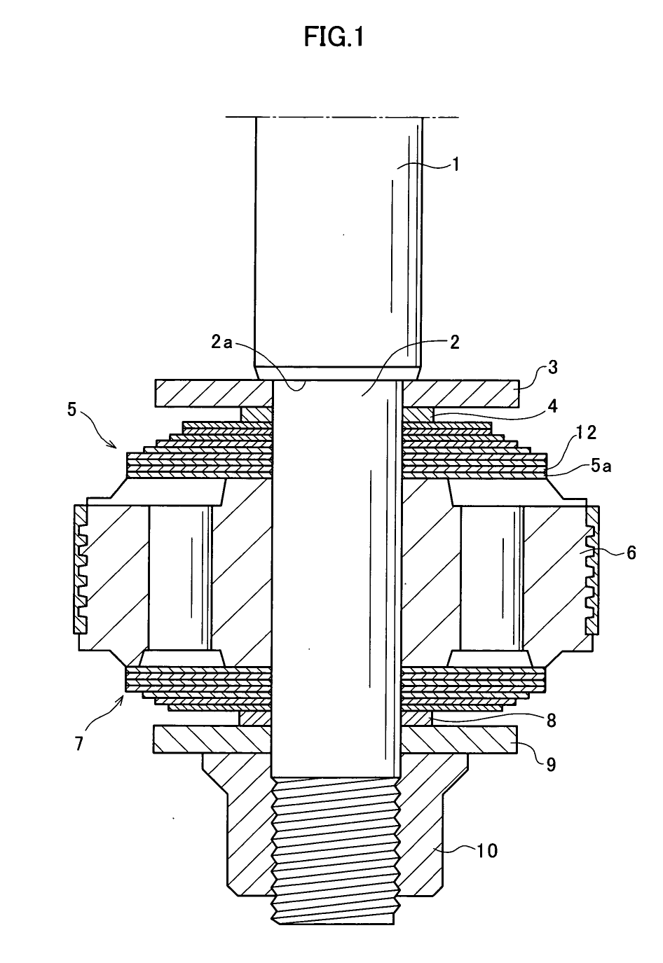

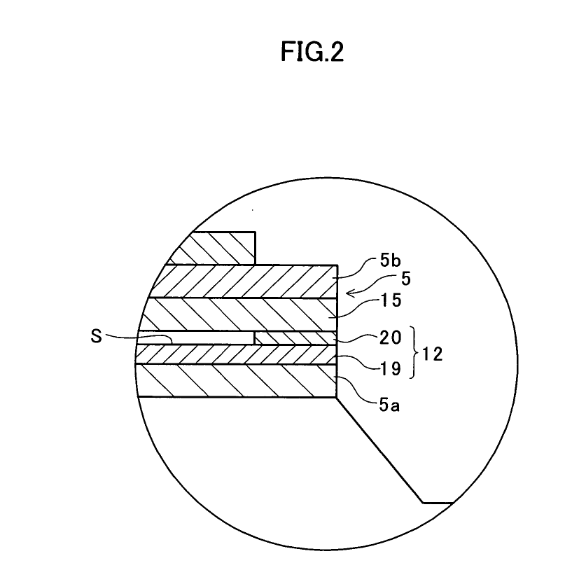

Referring to FIG. 1 and FIG. 2, a pressure side valve stopper 3, a spacer 4, a pressure side damping force generating valve 5 made from a plurality of leaf valves, a piston portion 6, an extension side damping force generating valve 7, a spacer 8, and an extension side valve stopper 9 are stacked in order on a spigot portion 2 of a piston rod 1. In addition, a nut 10 is screwed on from below the valve stopper 9. Each of the members described above is thus fixed with an applied compressive load between a base end portion 2a of the spigot portion 2, and the nut 10.

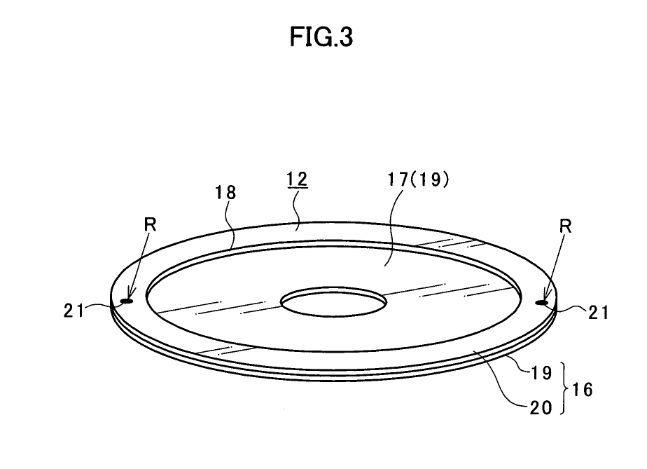

Referring to FIG. 3, a second leaf valve 12 is structured by a ring shaped thick portion 16 that is provided in an outermost circumferential portion, and a disk shaped thin portion 17 that is provided in a more inner circumferential side than the thick portion 16. A step portion 18 is formed between the thick portion 16 and the thin portion 17. Further, the thickness of the thick portion 16 and the thickness of the thin portion 17 are both constant.

The most characteristic feature of the present invention is that the thin portion 17 is provided by a disk shaped valve main body 19, and that the thick portion 16 is provided by the valve main body 19 and a ring shaped outside ring 20 which is fixed to the valve main body 19 by welding. Overall, this is one part. The outside ring 20 is fixed to the valve main body 19 at two opposite locations (points R in FIG. 3) by electric resistance welding. The outside ring 20 functions as an initial load generating portion.

The second leaf valve 12 can therefore be attached without work for assembling two separate parts, as with the conventional valve example.

Electric resistance welding is explained here. This type of welding is one in which voltage is applied to a welding material by electrodes, and a large amount of current flows in a short period of time in an electric pathway formed by this applied voltage. Resistance heating takes place, and the welding material is melted and fixed in place. The valve main body 19 and the outside ring 20 are fixed in this embodiment by welding, with joining surfaces of the valve main body 19 and the outside ring 20 used as the welding material.

A method of manufacturing the second leaf valve 12 by using electric resistance welding is explained next.

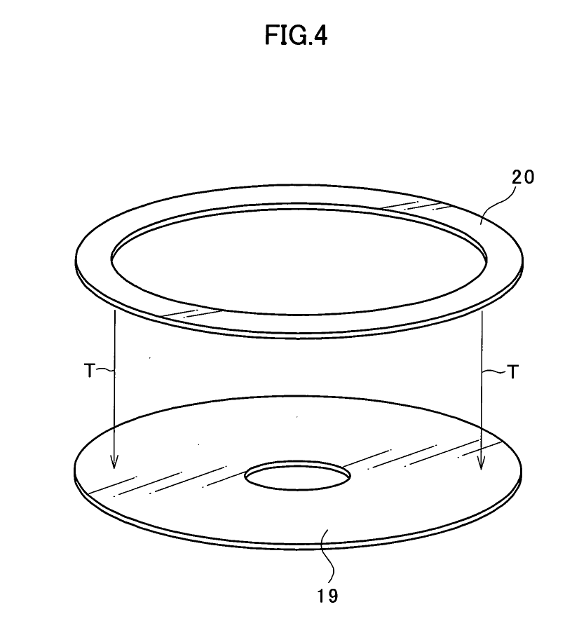

Referring to FIG. 4, first the disk shaped valve main body 19 and the outside ring 20 are provided as separate members having identical diameters. The outside ring 20 is then placed on an upper surface of the valve main body 19, as shown by arrows T, with the centers of the valve main body 19 and the outside ring 20 made to coincide.

Referring to FIG. 3, voltage is applied next to the two opposite locations (the points R of FIG. 3) by electrodes (not shown), causing a large amount of current to flow in a short amount of time; and causing resistance heating. The joining surfaces of the valve main body 19 and the outside ring 20 melt, and are fixed. The electrodes are disposed in a center portion in a width direction of the outside ring 20 in this embodiment. Welding current, electrode welding force, and a diameter size of an electrode tip are regulated in order to make depressed portions 21, which develop during welding, impart no influence to the step portion 18, and in order to contain spatters, which are generated during welding, within the depressed portions 21.

The following effects are obtained in accordance with the embodiment described above.

The second leaf valve 12 can be made into a single part, and therefore the number of parts can be reduced when compared with conventional damping force generating valves.

With conventional leaf valves, the thick outer circumference valve may ride up on the thin inner circumference valve during assembly, resulting in assembly failures, during assembly of the outer circumference valve in the outer periphery of the inner circumference valve if positioning is not performed accurately. The assembly work must therefore be performed carefully, and it is difficult to shorten the amount of time needed for assembly. This problem does not develop with this embodiment, however, and the assembly time can be shortened. In addition, the assembly costs can also be reduced.

Further, welding sites for the outside ring 20 and the valve main body 19 are at two opposite locations, and therefore the welding time can be shortened, and the influence of heat when welding the outside ring 20 and the valve main body 19 can be reduced.

In addition, the welding sites for the outside ring 20 and the valve main body 19 are the center portions in the width direction of the outside ring 20. Therefore the depressed portions 21, which are formed by welding, can be dependably prevented from changing the shape of an inner circumferential edge portion, or an outer circumferential edge portion of the outside ring 20, and imparting any influence on the basic functionality of the valve.

Furthermore, the welding current, the electrode welding force, and the diameter size of the electrode tip are regulated to keep spatters generated during welding within the depressed portions 21. Spatters can therefore be prevented from adhering to surface portions of the outside ring 20 other than the depressed portions 21. The basic functionality of the valve can therefore be ensured.

Further, the step portion 18 is formed between the thin portion 17 and the thick portion 16, and therefore the size of the gap S formed by the step portion 18 are easy to manage.

Note that the present invention is not limited to the embodiment described above. The following changes may be made, for example.

1) It is explained in the embodiment described above that the thickness of the thick portion 16 and the thickness of the thin portion 17 are both uniform. This is not always necessary, however. An inclined surface where the thickness becomes gradually thinner toward the inner circumference side from the outer circumference side may also be used.

2) The thick portion 16 is provided in the outermost circumference in the embodiment described above, but it is not always necessary to provide the thick portion 16 in the outermost circumference. For example, the thick portion 16 may also be provided in an intermediate portion between the outermost circumference and an innermost circumference. The position may be changed arbitrarily according to the initial load generated.

3) The initial load generating portion is provided only in the upper side of the damping force generating valve in the embodiment described above. The initial load generating portion naturally may also be provided in a lower side of the damping force generating valve, and further, may also be provided in both sides.

4) The ring shaped outside ring 20 is used as the initial load generating portion in the embodiment described above. It is not always necessary to use a ring shaped, however. A semicircular arc shape or a fan shape may also be used.

5) Welding using electric resistance welding is performed at two locations in the embodiment described above, but it is not always necessary that welding be performed at two locations. Four locations, six locations, and the like may also be employed, and the number of locations may be suitably changed.

What is claimed is:

1. A damping force generating valve of a hydraulic shock absorber, comprising:
a piston portion in the hydraulic shock absorber;
an extension side port and a pressure side port drilled in the piston portion; and
a plurality of leaf valves that are seated so as to be capable of opening and closing one of the extension side port and the pressure side port, which are disposed in the piston portion in a stacked state, and which are fixed to an inner circumferential side;
wherein at least one leaf valve of the plurality of leaf valves has:
a thin sheet valve body; and
a thick portion provided along a circumferential direction in an intermediate portion of the thin sheet valve body, or in an outer edge side of the thin sheet valve body, contacting adjacent leaf valves.

2. The damping force generating valve of a hydraulic shock absorber as defined in claim 1, wherein the thick portion is provided by a ring that is disposed in at least one side of the thin sheet valve body.

3. The damping force generating valve of a hydraulic shock absorber as defined in claim 2, wherein the ring is fixed at two opposing locations in a radial direction with respect to the thin sheet valve body.

4. The damping force generating valve of a hydraulic shock absorber as defined in claim 2, wherein the ring is fixed by electric resistance welding.

5. The damping force generating valve of a hydraulic shock absorber as defined in claim 2, wherein the ring is fixed at a center portion in a width direction of the ring.
